(19) United States
(12) Patent Application Publication
(10) Pub. No.: US 2006/0230036 A1
(43) Pub. Date: Oct. 12, 2006

(54) Information processing apparatus, information processing method and program

(76) Inventor: Kei Tateno, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/390,290

(22) Filed: Mar. 28, 2006

(30) Foreign Application Priority Data
Mar. 31, 2005 (JP) P2005-101963

(51) Int. Cl. G06F 17/30

(52) U.S. Cl. 707/5

(57) ABSTRACT

The present invention provides a method for extracting a characteristic word for a given keyword. The user specifies a keyword as domain knowledge in order to extract a characteristic word from a text such as a text related to a field serving as a domain. For example, the user desires to extract a characteristic word representing a musical characteristic of a song or a musical characteristic of an artist from a musical-CD music review text serving as a text in a musical field. In this case, as a keyword, the user specifies a word such as ‘sound,’ ‘style’ or ‘voice,’ which by itself does not represent a concrete musical characteristic. However, it can be expected that the word such as ‘sound,’ ‘style’ or ‘voice’ is modified by a word such as ‘clear’ or ‘steric,’ which by itself represents a musical characteristic. By specifying a word such as ‘sound,’ ‘style’ or ‘voice’ as a keyword, a word modifying the specified word can be extracted from the original text. The word extracted from the music review text as a word modifying the keyword is a word suitable for expressing the contents of the text, that is, the musical characteristic of the musical CD.

### CROSS REFERENCES TO RELATED APPLICATIONS

The present invention contains subject matter related to Japanese Patent Application JP 2005-101963 filed in the Japanese Patent Office on Mar. 31, 2005, the entire contents of which being incorporated herein by reference.

### BACKGROUND OF THE INVENTION

The present invention relates to an information processing apparatus, an information processing method adopted by the information processing apparatus and a program implementing the information processing method. More particularly, the present invention relates to an information processing apparatus capable of properly extracting a characteristic word from a text as a word characterizing the contents of the text, an information processing method adopted by the information processing apparatus and a program implementing the information processing method.

A characteristic-word extraction technology for selecting a word playing an important role in the contents of a sentence (or text data) from the sentence is very important in efficient classification and clustering of texts.

The characteristic-word extraction technology adopts a TF/IDF method disclosed in “Introduction to Modern Information Retrieval” (by Salton, G., McGill, M. J., McGraw-Hill, 1983) as a heuristic method based on word weighting, a method disclosed in “Automatic Extraction of Keywords from Japanese Texts” (by Nagao et al., Information Processing, Vol. 17, No. 2, 1976) as a statistical method of utilizing an X² value for a document text and a method introduced in Japanese Patent Laid-Open No. 2001-67362. If a document text and its categorization class are given as learning data, the characteristic-word extraction technology adopts a method disclosed in “A Comparative Study on Feature Selection in Text Categorization” (by Yang, Y., Pedersen, J. O., Proc. of ICML-97, pp. 412 to 420, 1997) as a method of utilizing an X² for the class and a method disclosed in “Induction of Decision Trees” (by Quinlan, J. R., Machine Leaning, 1 (1), pp. 81 to 106, 1986) as a method of utilizing an information gain.

### SUMMARY OF THE INVENTION

However, the methods described above are adopted with general co-paths taken as objects. In addition, the methods each merely utilize statistical properties of words in a pure manner. Thus, the methods are not capable of extracting words according to specialties of the contents of a sentence and according to a bias of a topic.

For example, the methods are not capable of extracting words representing musical characteristics of a song and musical characteristics of an artist from a musical review text recorded on a musical CD (Compact Disk). An example of the musical review text is sentences recorded on a CD as sentences introducing a song and an artist. That is to say, the methods are not capable of properly extracting a word (or a word representing a musical characteristic) dependent on a field (a musical field) according to the contents of a sentence.

An information processing apparatus provided by the present invention is configured so that the information processing apparatus includes acquisition means for acquiring a keyword representing a characteristic of domain knowledge and extraction means for extracting close words each having a distance scale approaching the keyword from a text and extracting a word having a high degree of occurrence with the keyword among the close words as a characteristic word for the keyword by associating the characteristic word with the keyword.

An information processing method provided by the present invention is configured so that the information processing method includes an acquisition step of acquiring a keyword representing a characteristic of domain knowledge and an extracting step of extracting close words each having a distance scale approaching the keyword from a text and extracting a word having a high degree of occurrence with the keyword among the close words as a characteristic word for the keyword by associating the characteristic word with the keyword.

A program provided by the present invention is configured so that the program includes an acquiring step of acquiring a keyword representing a characteristic of domain knowledge and an extracting step of extracting close words each having a distance scale approaching the keyword from a text and extracting a word having a high degree of occurrence with the keyword among the close words as a characteristic word for the keyword by associating the characteristic word with the keyword.

In accordance with the information processing apparatus, the information processing method and the program, which are provided by the present invention, a keyword is acquired and a word modifying the keyword is extracted from a text as a characteristic word.

In accordance with the present invention, it is possible to extract a characteristic word from a text as a word characteristic to the contents of the text.

### BRIEF DESCRIPTION OF THE DRAWINGS

FIG. 1 is a diagram showing a typical configuration of an information processing apparatus provided by the present invention;

FIG. 2 is a table showing a typical word model;

FIG. 3 is a table showing typical co-occurrence frequencies;

FIG. 4 shows a flowchart representing processing to extract characteristic words;

FIG. 5 is a table showing KL distances among words;

FIG. 6 is a table showing typical amounts of mutual information among words;

FIG. 7 is a diagram showing another typical configuration of the information processing apparatus provided by the present invention;

FIG. 8 shows a flowchart representing other processing to extract characteristic words; and

FIG. 9 is a block diagram showing a typical configuration of a personal computer.

### DETAILED DESCRIPTION OF THE PREFERRED EMBODIMENTS

Before preferred embodiments of the present invention are explained, relations between disclosed inventions and the embodiments are explained in the following comparative description. It is to be noted that, even if there is an embodiment described in this specification but not included in the following comparative description as an embodiment corresponding to an invention, such an embodiment is not to be interpreted as an embodiment not corresponding to an invention. Conversely, an embodiment included in the following comparative description as an embodiment corresponding to a specific invention is not to be interpreted as an embodiment not corresponding to an invention other than the specific invention.

In addition, the following comparative description is not to be interpreted as a comprehensive description covering all inventions disclosed in this specification. In other words, the following comparative description by no means denies existence of inventions disclosed in this specification but not included in claims as inventions for which a patent application is filed. That is to say, the following comparative description by no means denies existence of inventions to be included in a separate application for a patent, included in an amendment to this specification or added in the future.

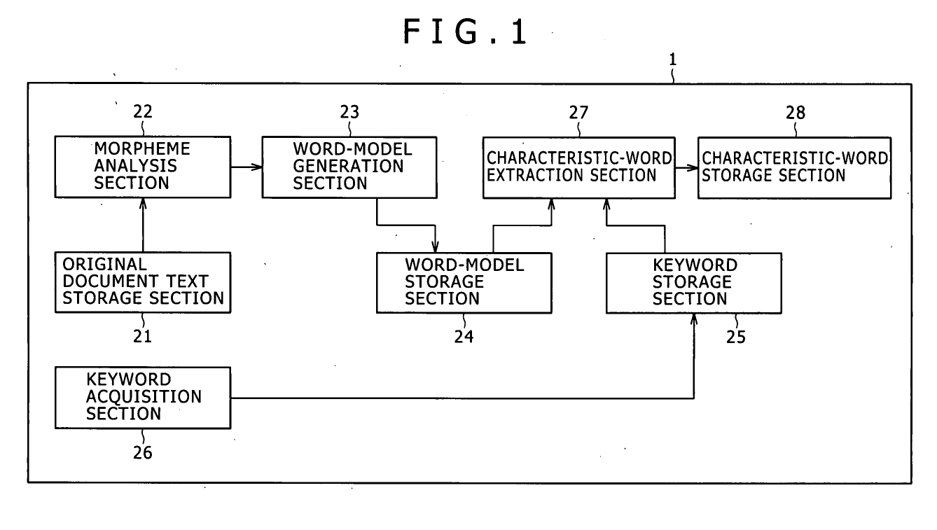

In accordance with an embodiment of the present invention, there is provided an information processing apparatus configured so that the information processing apparatus includes a keyword acquisition section (such as a keyword acquisition section 26 included in a configuration shown in FIG. 1) for acquiring a keyword and a characteristic-word extraction section (such as the characteristic-word extraction section 27 included in the configuration shown in FIG. 1) for extracting a word modifying the keyword from a text as a characteristic word.

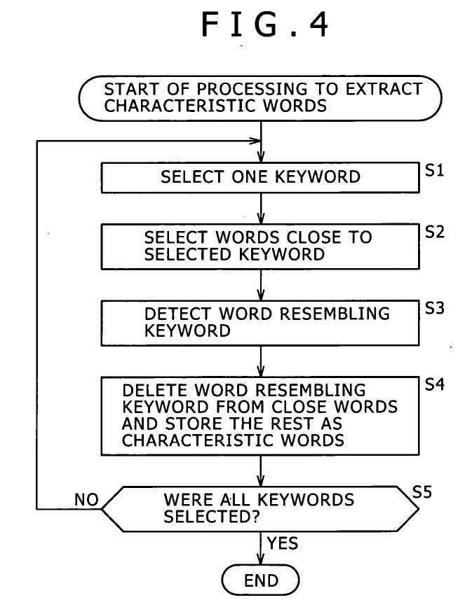

In accordance with another embodiment of the present invention, the information processing apparatus described above is further configured so that the characteristic-word extraction section is capable of extracting words close to a keyword as close words from a text (in a process such as a step S2 of a flowchart shown in FIG. 4), deleting a keyword resembling word having a meaning similar to the keyword from the close words and taking the remaining close words as characteristic words (in a process such as a step S4 of the flowchart shown in FIG. 4).

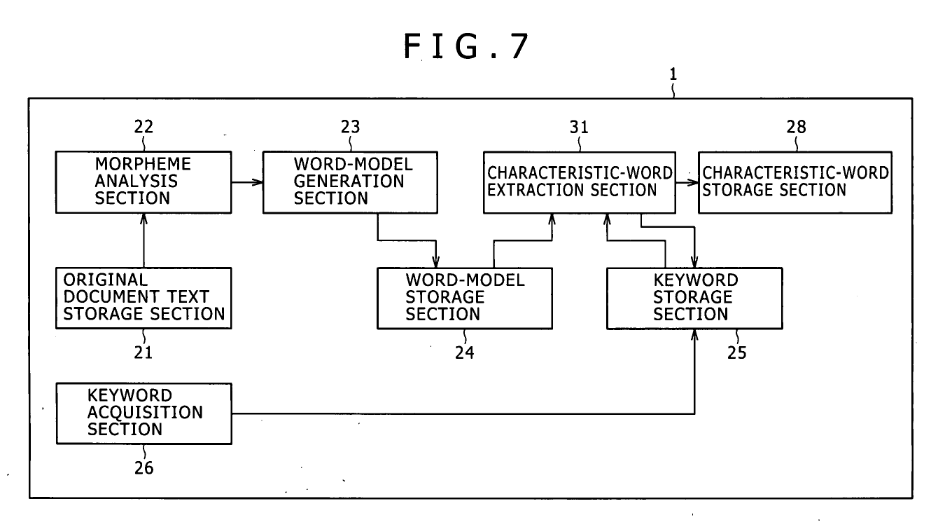

In accordance with a further embodiment of the present invention, the information processing apparatus described above is further configured so that the characteristic-word extraction section (such as a characteristic-word extraction section 31 included in a configuration shown in FIG. 7) is capable of using a keyword resembling word as a keyword.

In accordance with a still further embodiment of the present invention, there is provided an information processing method configured so that the information processing method includes a keyword acquisition step (such as a step S1 of the flowchart shown in FIG. 4) of acquiring a keyword and a characteristic-word extraction step (such as steps S2 to S5 of the flowchart shown in FIG. 4) of extracting a word modifying the keyword from a text as a characteristic word.

In accordance with a still further embodiment of the present invention, there is provided a program having the same steps as the information processing method described above.

FIG. 1 is a diagram showing a typical configuration of an information processing apparatus 1 provided by the present invention. The information processing apparatus 1 utilizes a keyword entered by the user as domain knowledge to extract a characteristic word from a text such as a text related to one field of the domain.

For example, it is desired to extract a characteristic word representing a musical characteristic of a song or a musical characteristic of an artist from a music review text recorded on a musical CD as a text in a musical field. In this case, by entering a word such as ‘sound,’ ‘style’ or ‘voice’ as a keyword, a word modifying the keyword can be extracted from the original text. The keyword such as ‘sound,’ ‘style’ or ‘voice’ itself does not represent a concrete musical characteristic. However, it can be expected that the keyword such as ‘sound,’ ‘style’ or ‘voice’ is modified by a word such as ‘clear’ or ‘steric,’ which by itself represents a musical characteristic. For example, the keyword such as ‘sound,’ ‘style’ or ‘voice’ may most likely appear along with the word such as ‘clear’ or ‘steric’ in a phenomenon referred to as a co-occurrence.

A word extracted from the text as a word modifying a keyword is a word suitable for representing the contents of the music review text, that is, representing the musical characteristics of the musical CD such as a CD including clear songs. In this example, typical words extracted from the text are ‘clear’ and ‘steric.’ Thus, by entering such a keyword and extracting a characteristic word corresponding to the keyword as described above, it is possible to extract a characteristic word of the musical field from a text related to the field. As described above, the characteristic word of the musical field is a word representing a musical characteristic. In this example, the text related to the musical field is a music review text.

For example, it is desired to extract a rarely appearing word as a characteristic word in the technology in related art. In this case, it is necessary to incorporate a condition for the word in an extraction technique itself. In accordance with the present invention, however, by properly selecting a keyword, a characteristic word according to the keyword can be extracted as a characteristic word having a certain semantic trend.

The typical configuration of the information processing apparatus 1 is explained as follows. An original document text storage section 21 is used for storing sentences (or text data) from which a characteristic word is to be extracted. In the case of this example, the sentences stored in the original document text storage section 21 are a review text of a musical CD.

A morpheme analysis section 22 is a section for splitting the text data (or sentences) stored in the original document text storage section 21 into words and supplying the words to a model-word generation section 23. Examples of the words are ‘sound,’ ‘acoustic image,’ ‘hard,’ ‘steric,’ ‘album’ and ‘do.’

The model-word generation section 23 is a section for converting words received from the morpheme analysis section 22 into a mathematical word model in order to see relations among the words and supplying the word model obtained as a result of the conversion to a model-word storage section 24.

The word model is a probability model such as a PLSA (Probabilistic Latent Semantic Analysis) and a SAM (Semantic Aggregate Model). In these word models, a latent variable exists behind co-occurrences between a sentence and a word or between a word and a word. The probabilistic occurrence determines individual expressions.

The PLSA is introduced in “Probabilistic Latent Semantic Analysis” authored by Hofmann, T. in Proc. of Uncertainty in Artificial Intelligence, 1999. On the other hand, the SAM is introduced in “Semantic Probability Expression” authored by Daichi Mochihashi and Yuji Matsumoto in Information Research Report 2002-NL-147, pp. 77 to 84, 2002.

In the case of the SAM, for example, the co-occurrence probability of the word wᵢ and the word wⱼ is expressed by Equation (1) in terms of a latent probability variable c, which is a variable probably having one of k values c₀, c₁, . . . cₖ₋₁ determined in advance. From Equation (1), a probability distribution P (c|w) for the word w can be determined as shown in Equation (2). The probability distribution P (c|w) is a word model. The probability variable c in Equation (1) is a latent variable. The probability distribution P (w|c) and the probability distribution P (c) are found by using an EM algorithm.

$$P ( {w}_{i} , {w}_{j} ) = {\sum }_{c} P ( c ) P ( {w}_{i} \text{\vert} c ) P ( {w}_{j} \text{\vert} c ) \qquad ( 1 )$$

P(c|w)∝P_(w|c)P(c) (2)

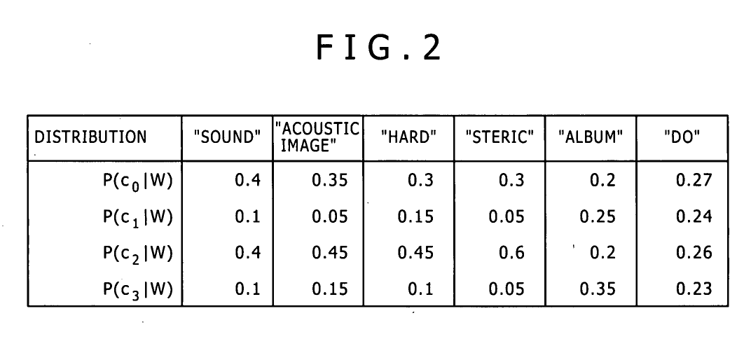

For example, from the words w such as ‘sound,’ ‘acoustic image,’ ‘hard,’ ‘steric,’ ‘album’ and ‘do,’ the word model (P (cᵢ|w) (i=0, 1, 2, 3)) like the one shown in FIG. 2 is obtained.

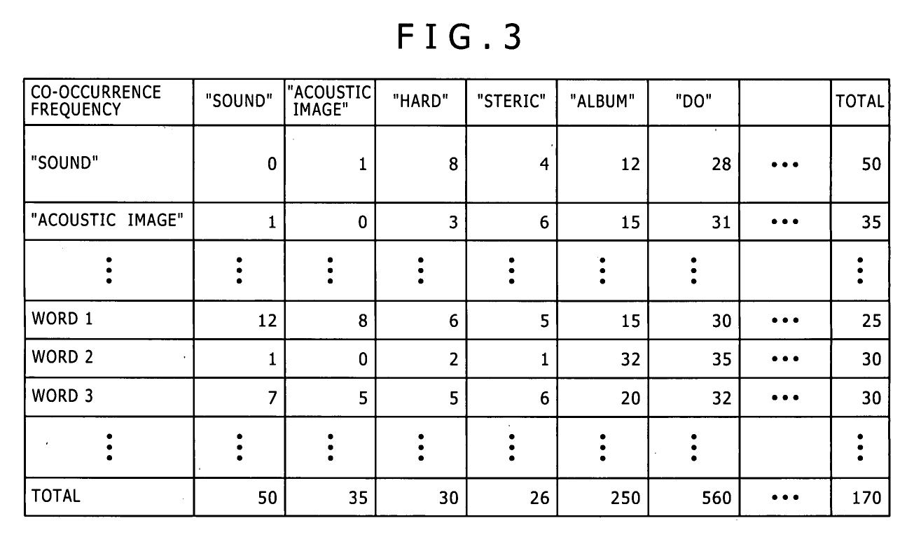

It is to be noted that, in the SAM, if the co-occurrence trend of a word with respect to another word is similar, their probability distributions are also similar to each other. An example of the co-occurrence trend of a word with respect to another word is the number of times both the words are used in one sentence. To put it concretely, the co-occurrence trends of the words ‘sound,’ ‘acoustic image,’ ‘hard’ and ‘steric’ with respect to words 1 to 3 are similar to each other. That is to say, the frequencies of co-occurrence of the words ‘sound,’ ‘acoustic image,’ ‘hard’ and ‘steric’ with the words 1 and 3 are all high while the frequencies of co-occurrence of the words ‘sound,’ ‘acoustic image,’ ‘hard’ and ‘steric’ with the word 2 are all low as shown in FIG. 3. In this case, the probability distributions of the words ‘sound,’ ‘acoustic image,’ ‘hard’ and ‘steric’ have the same trend. That is to say, for all the words ‘sound,’ ‘acoustic image,’ ‘hard’ and ‘steric,’ P (c₀|w) and P(c₂|w) are large while P (c₁|w) and P(c₃|W) are small as shown in FIG. 2.

On the other hand, the co-occurrence trends of the words ‘sound,’ ‘acoustic image,’ ‘hard’ and ‘steric’ with respect to the words 1 to 3 are not similar to the co-occurrence trends of the words ‘album’ and ‘do’ with respect to the words 1 to 3 as shown in FIG. 3. In this case, the probability distributions of the words ‘sound,’ ‘acoustic image,’ ‘hard’ and ‘steric’ each have a trend different from the trend of the probability distributions of the words ‘album’ and ‘do’ as shown in FIG. 2. It is to be noted that the probability distribution of an ordinary word such as the word ‘do’ approaches a discrete uniform distribution as is generally known.

In addition to the probability models such as the PLSA and the SAM, as a word model, it is possible to use vectors such as a text vector, a co-occurrence vector and a semantic vector already subjected to a dimension compression process by using a technique such as an LSA (Latent Semantic Analysis). One of these vectors can be selected arbitrarily. It is to be noted that since the PLSA and the SAM express a word in a space of latent probability variables as described above, a semantic trend can be grasped with ease in comparison with use of an ordinary co-occurrence vector or the like.

The LSA is introduced in “Indexing by latent semantic analysis” authored by Deerwester, S. et al. in Journal of the Society for Information Science, 41 (6), pp. 391 to 407, 1990.

Refer back to FIG. 1. A keyword storage section 25 is used for storing words such as ‘sound,’ ‘style’ and ‘voice’ in this example as keywords.

Keywords are collected in this example from words entered by the user operating an operation section shown in none-of the figures. A keyword acquisition section 26 is a section for acquiring keywords entered via the operation section. The keyword storage section 25 is a memory used for storing the acquired keywords.

It is to be noted that a keyword can be selected arbitrarily among source words for example as long as it can be expected that the source words are each modified by a characteristic word even though the source words themselves do not represent a domain. That is to say, a source word may most likely appear along with a characteristic word in a phenomenon referred to as a co-occurrence. For example, a source word is a word used at a usage frequency higher than a predetermined value.

In addition, by having more variations of keywords, it is possible to provide a wider range of extractable characteristic words. For example, as will be described later, the words ‘acoustic image’ can be used as a keyword. Since the words ‘acoustic image’ are semantically similar to the word ‘sound,’ that is, since both the words ‘acoustic image’ and the word ‘sound’ are words expressing a sound quality, by using the word ‘sound’ as a keyword, the degree of necessity to select the words ‘acoustic image’ as a new keyword decreases. By using a word representing a concept orthogonal to the word ‘sound’ as a keyword, however, it is possible to extract a characteristic word different from a characteristic word that can be extracted by using the word ‘sound.’ Examples of the word representing a concept orthogonal to the word ‘sound’ are the words ‘tempo’ and ‘development.’

A characteristic-word extraction section 27 uses a word model stored in the model-word storage section 24 to extract a word as a characteristic word and stores the extracted word in a characteristic-word storage section 28. The extracted word is a word modifying a keyword stored in the keyword storage section 25. That is to say, the extracted characteristic word is typically a word most likely appearing along with the keyword in a phenomenon referred to as a co-occurrence.

Next, characteristic-word extraction processing is explained by referring to a flowchart shown in FIG. 4.

As shown in the figure, the flowchart begins with a step S1 at which the characteristic-word extraction section 27 selects one of keywords stored in the keyword storage section 25.

Then, at the next step S2, the characteristic-word extraction section 27 uses a word model stored in the model-word storage section 24 to select words each close to the keyword selected in a process carried out at the step S1. In the following description, a word close to a keyword is referred to as a close word.

To put it concretely, the characteristic-word extraction section 27 uses a distance scale according to the word model to find a distance between the keyword and a word. If the distance between the keyword and the word is smaller than a predetermined value, the word is taken as a close word.

If the word model is a probability model, a Kullback-Leibler Divergence distance can be used as a distance scale. In the following description, the Kullback-Leibler Divergence distance is referred to as a KL distance. If the word model is a vector space method, on the other hand, a Euclid distance or a cosine distance can be used.

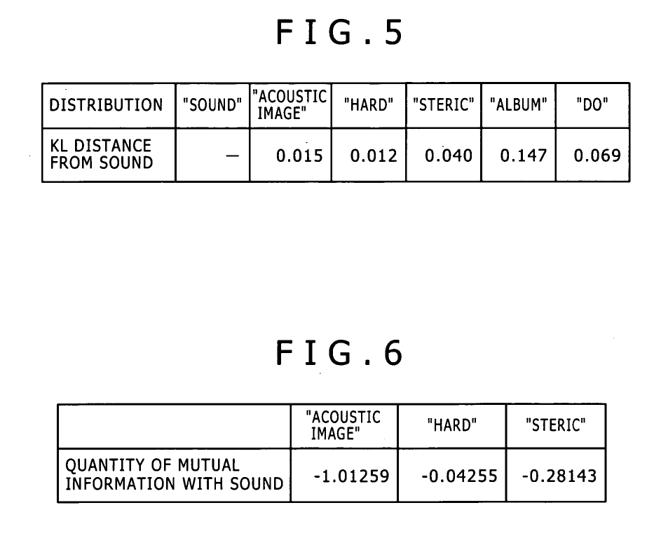

If the word model is the SAM, as shown in FIG. 5 for example, the KL distances between the keyword ‘sound’ and the words ‘acoustic image,’ ‘hard,’ ‘steric,’ ‘album’ and ‘do’ are 0.015, 0.012, 0.040, 0.147 and 0.069 respectively. If the threshold value is 0.05, the words ‘acoustic image,’ ‘hard’ and ‘steric’ are each a close word of the keyword ‘sound.’ In the case of the KL distance between the keyword ‘sound’ and the words ‘acoustic image,’ for example, the distance from the keyword ‘sound’ to the word ‘acoustic image’ is different from the distance from the words ‘acoustic image’ to the keyword ‘sound.’ The KL distances shown in FIG. 5 are each an average value of distances in the two directions.

Then, at the next step S3, the characteristic-word extraction section 27 detects a keyword resembling word of the keyword selected in a process carried out at the step S1. A keyword resembling word of a keyword is a word semantically identical with the keyword.

In general, the distance scale according to the word model used for selecting a close word decreases for a word prone to co-occurrences and a keyword semantically-resembling word. That is to say, a word most likely co-occurring with a keyword or a word semantically identical with a keyword is selected as a close word of the keyword.

As an indicator of the co-occurrence degree, a quantity such as a mutual information amount, an X² value or a dice coefficient is known.

In this case, since it is desired to extract a word most likely co-occurring with the keyword, the characteristic-word extraction section 27 uses the quantity such as the mutual information amount, the X² value or the dice coefficient to compute the degree of co-occurrence with the keyword selected in a process carried out at the step S1 and the degree of co-occurrence with the close word selected in a process carried out at the step S2. Then, the characteristic-word extraction section 27 takes a word having an occurrence degree not exceeding a predetermined value as a close word semantically resembling the keyword and takes the close word semantically identical with the keyword as the keyword resembling word.

For example, the mutual information amounts between the keyword ‘sound’ and the words ‘acoustic image,’ ‘hard’ and ‘steric’ are typical values shown in FIG. 6. In this case, as is obvious from the typical values shown in the figure, the mutual information amount between the keyword ‘sound’ and the phrase ‘acoustic image’ is smaller than the mutual information amounts between the keyword ‘sound’ and the words ‘hard’ and ‘steric,’ indicating that the phrase ‘acoustic image’ hardly co-occurs with the word ‘sound.’ That is to say, the phrase ‘acoustic image’ is selected for the keyword ‘sound’ as a close word semantically identical with the keyword ‘sound.’

In actuality, the words ‘acoustic image’ and ‘sound’ are words describing a sound quality and they have about the same meaning. However, they are used independently of each other in sentences like “The sound is steric.” and “The acoustic image is steric.” and, therefore, there is hardly a case in which the words ‘acoustic image’ and ‘sound’ co-occur.

A keyword resembling word of a keyword is a word semantically identical with the keyword as described above. It is to be noted, however, that this definition implies that a keyword resembling word of a keyword can become the keyword. The keyword itself is not a word representing a characteristic of a domain, but it can be expected that the keyword is modified by a characteristic word.

Then, at the next step S4, the characteristic-word extraction section 27 removes a keyword resembling word detected in a process carried out at the step S3 from close words detected in a process carried out at the step S2. The characteristic-word extraction section 27 takes the remaining close word as a characteristic word and stores the characteristic word in the characteristic-word storage section 28.

Then, at the next step S5, the characteristic-word extraction section 27 produces a result of determination as to whether or not all keywords have been selected. If the result of the determination indicates that a keyword still remains to be selected, the flow of the processing goes on to a step S1 at which a next keyword is selected. Then, the processes of the step S2 and the subsequent steps are carried out in the same way.

If the determination result produced in a process carried out at the step S5 indicates that all keywords have been selected, on the other hand, the execution of this processing is ended.

As described above, a word modifying a keyword (a word co-occurring with a keyword) is extracted as a characteristic word. Thus, if the word ‘sound’ is entered as a keyword, for example, characteristic words each modifying the keyword (or words each describing a musical characteristic) can be extracted from a music review text. Typical characteristic words each modifying the keyword ‘sound’ are ‘hard’ and ‘steric.’

That is to say, if a music review text of a musical CD is displayed by placing an emphasis on a characteristic word extracted from the text, for example, it is possible to provide the user with a musical-CD introducing screen allowing the user to easily recognize a word expressing a musical characteristic.

In addition, as described above, if an extracted characteristic word is used as metadata to be used to set matching with information representing favorite of the user, it is possible to recommend a song serving more as a favorite of the user in the musical characteristics.

Since ordinary metadata also includes words loosely related to a musical characteristic, in comparison with establishment of matching by using such loosely related words, establishment of matching by using only characteristic words extracted in accordance with the present invention as characteristic words describing a musical characteristic makes it possible to recommend a song to the user as a song serving more as a favorite of the user as seen from the musical-characteristic point of view. Examples of the words loosely related to a musical characteristic are a word describing a sales area and a word related to an idol characteristic of an artist. It is to be noted that, naturally, by extracting a characteristic word describing an idol characteristic of an artist as a characteristic word for a keyword ‘figure’ or ‘idol,’ it is possible to recommend a song serving as a favorite seen from the idol-characteristic point of view.

By specifying one of company names ABC, abc and ABC Corp each representing the name of ABC Corporation as a keyword, characteristic words can be extracted from a news article in a newspaper. Typical characteristic words include ‘favorable’ and ‘progress’ revealing a good financial condition. In other words, domain knowledge related to ABC Corporation can be represented by one word, that is, one of the company names ABC, abc and ABC Corp.

As described above, a characteristic word extracted in accordance with the present invention can be used.

In the above description, only keywords stored in advance in the keyword storage section 25 are used. Since a keyword resembling word removed from close words can be used as a keyword as described above, however, the removed keyword resembling word can be used as an additional keyword.

FIG. 7 is a block diagram showing a typical configuration of the information processing apparatus 1 for a case in which a removed keyword resembling word is used as an additional keyword. The information processing apparatus 1 shown in the figure employs a characteristic-word extraction section 31 as a substitute for the characteristic-word extraction section 27 included in the configuration shown in FIG. 1. Other sections in the configuration shown in FIG. 7 are the same as the configuration shown in FIG. 1.

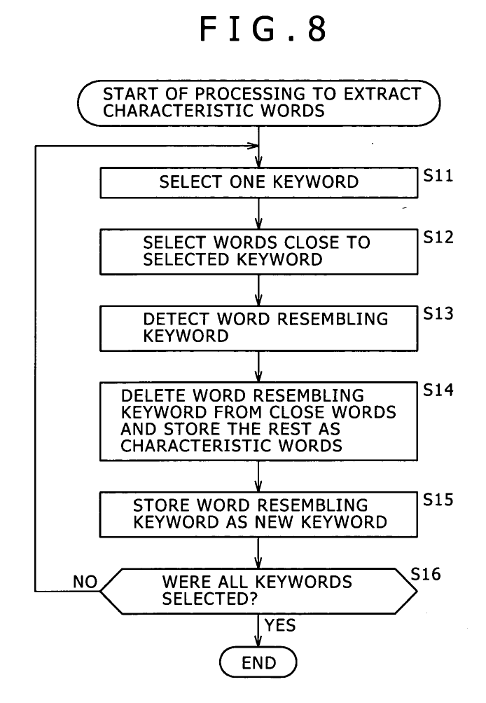

Processing carried out by the characteristic-word extraction section 31 to extract a characteristic word is explained by referring to a flowchart shown in FIG. 8.

Processes carried out at steps S11 to S14 of the flowchart shown in FIG. 8 are identical with respectively the processes carried out at the steps S1 to S14 of the flowchart shown in FIG. 4. Thus, explanations of these processes are not repeated in order to avoid duplications.

In a process carried out at a step S15, the characteristic-word extraction section 31 stores a keyword resembling word detected in a process carried out at a step S13 in the keyword storage section 25 as an additional keyword.

Then, at the next step S16, the characteristic-word extraction section 31 produces a result of determination as to whether or not all keywords including the additional keyword stored in a process carried out at the step S15 have been selected. If the result of the determination indicates that a keyword still remains to be selected, the flow of the processing goes on to a step S11 at which a next keyword is selected. Then, the processes of the step S12 and the subsequent steps are carried out in the same way.

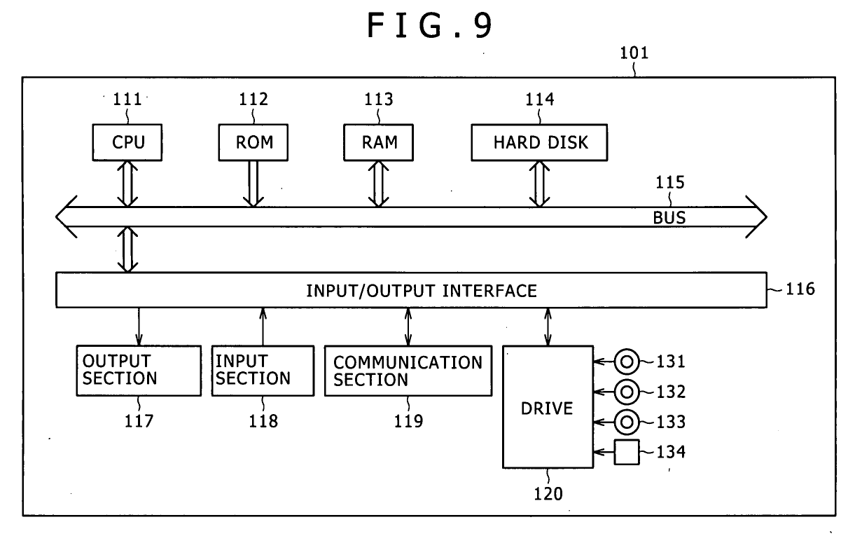

The series of processes described previously such as the series of processes in the processing to extract a characteristic word can be carried out by hardware and/or execution of software. If the series of processes described above is carried out by execution of software, programs composing the software can be installed into a computer embedded in dedicated hardware, a general-purpose personal computer or the like from typically a network or a recording medium. FIG. 9 is a block diagram showing the configuration of the computer or the personal computer. By installing a variety of programs into the general-purpose personal computer, the personal computer is capable of carrying out a variety of functions.

In the configuration shown in FIG. 9, a CPU (Central Processing Unit) 111 carries out various kinds of processing by execution of programs stored in a ROM (Read Only Memory) 112 or programs loaded from a hard disk 114 into a RAM (Random Access Memory) 113. The RAM 113 is also used for properly storing various kinds of information such as data required in execution of the processing.

The CPU 111, the ROM 112, the RAM 113 and the hard disk 114 are connected to each other by a bus 115, which is also connected to an input/output interface 116.

The input/output interface 116 is connected to an input section 118, an output section 117, and a communication section 119. The input section 118 includes a keyboard, a mouse, and an input terminal whereas the output section 118 includes a display unit and a speaker. The display unit can be a CRT (Cathode Ray Tube) display unit or an LCD (Liquid Crystal Display) unit. The communication section 119 has a device such as an ADSL (Asymmetric Digital Subscriber Line) modem, a terminal adaptor or a LAN (Local Area Network) card. The communication section 119 is a unit for carrying out communication processing with other apparatus through a network such as the Internet.

The input/output interface 116 is also connected to a drive 120 on which the aforementioned recording medium such as a removable medium is properly mounted. The recording medium can be a magnetic disk 131 including a floppy disk, an optical disk 132 including a CD-ROM (Compact Disk-Read Only Memory) and a DVD (Digital Versatile Disk), a magneto-optical disk 133 including an MD (Mini Disk), and a removable medium 134 including a semiconductor device. As described above, a computer program to be executed by the CPU 111 is installed from the recording medium into the hard disk 114 to be loaded eventually into the RAM 113.

It is also worth noting that, in this specification, steps of the flowchart described above can be carried out not only in a prescribed order along the time axis, but also parallelly or individually.

In addition, it should be understood by those skilled in the art that a variety of modifications, combinations, sub-combinations and alterations may occur in dependence on design requirements and other factors insofar as they are within the scope of the appended claims or the equivalents thereof.

It is also to be noted that the technical term ‘system’ used in this specification implies the configuration of a confluence including a plurality of apparatus.

What is claimed is:

1. An information processing apparatus comprising:
acquisition means for acquiring a keyword representing a characteristic of domain knowledge; and
extraction means for extracting close words each having a distance scale approaching said keyword from a text and extracting a word having a high degree of occurrence with said keyword among said close words as a characteristic word for said keyword by associating said characteristic word with said keyword.

2. The information processing apparatus according to claim 1, wherein said extraction means:
generates a word model serving as a mathematical model prescribing relations among words obtained as a result of a morpheme analysis carried out on text data; and
extracts said close words each having a distance scale approaching said keyword in said word model.

3. The information processing apparatus according to claim 1, wherein said extraction means extracts a word modifying said keyword as said characteristic word for said keyword.

4. The information processing apparatus according to claim 1, wherein said extraction means extracts a word having a low degree of occurrence with said keyword among said close words and uses said extracted word as an additional keyword.

5. The information processing apparatus according to claim 1, wherein said information processing apparatus further has processing means for:
acquiring a word representing a characteristic of another text from said other text;
selecting a keyword corresponding to said word representing said characteristic of said other text;
extracting said selected keyword and a characteristic word related to said selected keyword from said other text; and
carrying out a process to present said extracted characteristic word to a user.

6. An information processing method comprising the steps of:
acquiring a keyword representing a characteristic of domain knowledge; and
extracting close words each having a distance scale approaching said keyword from a text and extracting a word having a high degree of occurrence with said keyword among said close words as a characteristic word for said keyword by associating said characteristic word with said keyword.

7. A program recording medium for storing a program comprising the steps of:
acquiring a keyword representing a characteristic of domain knowledge; and
extracting close words each having a distance scale approaching said keyword from a text and extracting a word having a high degree of occurrence with said keyword among said close words as a characteristic word for said keyword by associating said characteristic word with said keyword.

8. An information processing apparatus comprising:
an acquisition section for acquiring a keyword representing a characteristic of domain knowledge; and
an extraction section for extracting close words each having a distance scale approaching said keyword from a text and extracting a word having a high degree of occurrence with said keyword among said close words as a characteristic word for said keyword by associating said characteristic word with said keyword.
